(19) United States
(12) Patent Application Publication
(10) Pub. No.: US 2019/0022750 A1
(43) Pub. Date: Jan. 24, 2019

(54) METHOD FOR PREPARING COPPER METAL NANOPOWDER HAVING UNIFORM OXYGEN PASSIVATION LAYER BY USING THERMAL PLASMA, AND APPARATUS FOR PREPARING SAME

(71) Applicant: POONGSAN HOLDINGS CORPORATION, Incheon (KR)

(72) Inventors: Daehyun KIM, Changwon-si (KR); Yunju CHO, Busan (KR)

(73) Assignee: POONGSAN HOLDINGS CORPORATION, Incheon (KR)

(21) Appl. No.: 16/069,868

(22) PCT Filed: Sep. 26, 2016
(86) PCT No.: PCT/KR2016/010773

§ 371 Date: Jul. 12, 2018

(30) Foreign Application Priority Data
Jan. 13, 2016 (KR) 10-2016-0004139

(51) Int. Cl. B22F 1/00; B33Y 70/00

(52) U.S. Cl. CPC B22F 1/0088; B22F 1/0018; C22C 9/00; B22F 2301/10; B22F 2304/054; B33Y 70/00

(57) ABSTRACT

A method for preparing a copper metal nanopowder having a uniform oxygen passivation layer and an apparatus for preparing the same are described. The method for preparing a copper metal nanopowder for light sintering, having an average diameter of 50-200 nm and an average thickness, of a surface oxygen passivation layer, of 1-30 nm, includes allowing copper or a copper alloy powder, having an average diameter of 5-30 μm, to pass through a thermal plasma torch, a reaction container and an oxygen reaction zone. The copper or the copper alloy powder is injected at an injection rate of 0.5-7 kg/hr and the amount of oxygen to be added to the oxygen reaction zone, per kg of the copper or the copper alloy powder to be injected per hour, is in the range of 0.3-12 standard liters per minute (slpm). Also described is a light sintering copper metal nanopowder preparation apparatus.

### TECHNICAL FIELD

Embodiments relate to a method for manufacturing a copper nano-metal powder having a uniform oxygen passivation layer using thermal plasma and an apparatus for manufacturing the same.

### BACKGROUND ART

Printed electronics is the field of manufacturing electronic devices, elements and modules by printing methods, is used to manufacture products with desired functions by printing conductive inks on plastics or paper, and is widely applicable in almost all fields utilizing semiconductors, elements, circuits and the like such as conventional radio frequency identification (RFID) tags, lighting, displays, solar cells and batteries.

The main reason for the fact that a killer application has not been developed yet in such a printed electronics industry is excessively expensive prices of silver ink and paste used for most electrode materials.

There have been attempts to use, as electrode materials, inexpensive nano-metal particles such as copper powder, instead of conventional silver ink or pastes. Although sintering is necessary to conduct an electrode process on printed wires, thermal sintering is generally used at present. Such a method requires a variety of equipment and a take-time of one hour or longer and, in particular, needs an additional device to create an inert gas atmosphere in order to conduct an electrode process on copper ink or the like, and has major drawbacks of low production yield and high price of un-oxidized pure nano-copper particles.

A novel white light sintering method based on intense pulsed light (IPL) that is capable of overcoming the drawbacks associated with thermal sintering and pure copper particles and of reducing oxidized particles as well as copper ink in air has recently been issued and is expected to improve competitiveness of electric and electronic materials and elements, and modulation companies, because it can complete sintering on printed wires and thus significantly reduce the process take-time by successfully conducting sintering under room temperature and atmospheric pressure within a short time of several microseconds (μs) to milliseconds (ms) by a white light ultra-short wavelength sintering method, and can further reduce the process take-time by replacing conventional expensive electrode materials with cheap copper electrode materials (corresponding to decrease by 80% or more of conventional electrode material prices) and replacing thermal sintering with light sintering.

The light sintering method is characterized in that copper nanoparticles having a high light absorbance and a low melting point as compared to bulk copper are printed in the form of an ink containing a reducing agent on a substrate and then sintered by irradiation with strong light for a short time, and when strong light is applied to the copper nano-particles containing a reducing agent, the copper nanoparticles absorb a great amount of light and are rapidly heated within a short time, the copper oxide film thermo-chemically reacts with the reducing agent contacting the same to produce water and intermediate-stage alcohols and reduce copper oxide into pure copper, and at the same time, induce welding of copper particles, which results in sintering to form a pure copper electrode. Light sintering enables reduction of the copper oxide film formed on the surface of copper nanoparticles and at the same time, induces welding copper nanoparticles to form a highly conductive pure copper electrode within several milliseconds (ms), and provides sintering in the presence of a room temperature atmosphere.

Here, synthesis of copper nanoparticles suitable for light sintering is an important issue. In this regard, at present, there is almost no technology to control an oxide passivation layer with optimized energy absorbance of irradiated light by synthesizing particles using wet- or thermal plasma and then oxidizing the same.

Korean Patent Laid-open No. 2012-0132115 discloses producing a copper particle complex with a particle size of 1 micron or less by reacting a copper salt as a precursor with formic acid, which utilizes a method clearly different from a thermal plasma-based method and has difficulty in securing uniform nanoparticles and a uniform oxide passivation layer with a scale of 100 nanometer.

In addition, Korean Patent Laid-open No. 2012-0132424 discloses producing a nano-copper ink with a size of 10 to 200 nm suitable for light sintering using a copper precursor. This is also totally different from the thermal plasma-based method, and has difficulty in securing stable nano-particles and controlling the uniform oxide passivation layer, which is an element important for light sintering, because it inevitably involves incorporation of impurities associated with cleaning due to a wet-type production method, unlike a dry-type production method with excellent dispersibility and dispersibility defects caused by dry agglomeration.

Unlike the wet-type production methods having these drawbacks, methods for preparing a highly pure metal powder using RF thermal plasma are disclosed in Japanese Patent Laid-open No. 2001-342506 and Japanese Patent Laid-open No. 2002-180112. Japanese Patent Laid-open No. 2001-342506 discloses preparing a highly pure metal powder of tungsten, molybdenum or the like using thermal plasma from a powder obtained by grinding a metal block, and Japanese Patent Laid-open No. 2002-180112 discloses a high-melting point oxide or metal powder of tungsten, ruthenium or the like with an average particle diameter of 10 to 320 μm.

However, the prior art has a limitation on realizing high-purity through thermal plasma of a high melting point metal and difficulty in stably securing a copper nano-powder with a controlled oxide passivation layer which is an essential element for light sintering.

### PRIOR ART DOCUMENT

(Patent Document 1) Korean Patent Laid-open No. 2012-0132115

(Patent Document 2) Korean Patent Laid-open No. 2012-0132424

(Patent Document 3) Japanese Patent Laid-open No. 2001-342506

(Patent Document 4) Japanese Patent Laid-open No. 2002-180112

### DISCLOSURE

### Technical Problem

Accordingly, in an attempt to secure optimal light sintering characteristics, the present inventors used the same thermal plasma as the prior art and controlled a rate at which a raw material powder is injected into a thermal plasma torch in order to obtain a nano-copper metal powder having an optimal oxygen passivation layer that is more stable and more suitable for light sintering, and a passage area and amount of added oxygen so as to form a uniform oxygen passivation layer in a line disposed at the back end of a reactor and, as a result, found the fact that production of a nanocopper metal powder with a uniform oxygen passivation layer was possible, thereby completing the present invention.

Accordingly, an object of the present invention is to provide a method for manufacturing a nano-copper metal powder suitable for light sintering and an apparatus for manufacturing the same.

### Technical Solution

The object of the present invention can be achieved by providing a method for preparing a nanocopper metal powder for light sintering having a mean particle diameter of 50 to 200 nm and a mean thickness of a surface oxygen passivation layer of 1 to 30 nm, including allowing a copper or copper alloy powder with a mean particle diameter of 5 to 30 μm to pass through a thermal plasma torch, a reactor and an oxygen reaction zone, wherein the copper or copper alloy powder is injected at an injection rate of 0.5 to 7 kg/hr, and the amount of oxygen added to the oxygen reaction zone with respect to 1 kg of the copper or copper alloy powder injected per hour ranges from 0.3 to 12 slpm (standard liters per minute).

In another aspect of the present invention, provided is an apparatus for preparing a nanocopper metal powder for light sintering including a raw material feeder for feeding a raw material powder, a thermal plasma torch having a thermal plasma high-temperature zone, a reactor for converting the fed raw material powder into nanoparticles through thermal plasma, and an oxygen injector for adding oxygen for passivation reaction.

### Advantageous Effects

Using the method according to the present invention, a controlled nanocopper metal powder suitable for light sintering that has a mean particle diameter of 50 to 200 nm and a uniform oxygen passivation layer having a mean thickness of 1 to 30 nm can be stably secured.

### DESCRIPTION OF DRAWINGS

FIG. 1 is a schematic diagram illustrating a thermal plasma apparatus according to an embodiment of the present invention;

FIG. 2 is a microscopic image showing a copper raw material powder before plasma treatment;

FIG. 3 shows a nanocopper metal powder undergoing plasma treatment without addition of oxygen and then exposure to oxygen in the air according to Comparative Example 7, which shows that an oxygen passivation layer is very non-uniformly formed on the surface; and

FIG. 4 shows a nanocopper metal powder having an oxygen passivation layer suitable for light sintering manufactured by plasma treatment based on uniform oxygen addition in Example 1 of the present invention, which shows that an oxygen passivation layer is uniformly formed on the metal powder surface layer.

### BEST MODE

The present invention relates to a method of obtaining a nanocopper metal powder for light sintering having a uniform oxygen passivation layer by suitably controlling a rate at which a raw material powder is injected into a thermal plasma torch, and a passage area and an amount of added oxygen so as to form a uniform oxygen passivation layer in a line disposed at the back end of a reactor, while using the conventional thermal plasma method, in order to obtain a nano-copper metal powder having an optimal oxygen passivation layer that is more stable and more suitable for light sintering.

Hereinafter, the present invention will be described in detail.

The present invention provides a method for preparing a nanocopper metal powder for light sintering that has a mean particle diameter of 50 to 200 nm and a surface oxygen passivation layer with a mean thickness of 1 to 30 nm including allowing a copper or copper alloy powder with a mean particle diameter of 5 to 30 μm to pass through a thermal plasma torch, a reactor and an oxygen reaction zone, wherein the copper or copper alloy powder is injected at an injection rate of 0.5 to 7 kg/hr, and the amount of oxygen added to the oxygen reaction zone with respect to 1 kg of the copper or copper alloy powder injected per hour ranges from 0.3 to 12 standard liters per minute (slpm).

The raw material powder for manufacturing the nanocopper metal powder for light sintering according to the present invention may be a copper or copper alloy powder, and the purity of the copper powder is not limited and is preferably 93% or more, more preferably 95% (2N rating). In addition, the copper alloy may be Cu—P, Cu—Ag, Cu—Fe or the like, and an alloy ratio of copper to other metal is 99:1 to 95:5 on a weight basis, but the present invention is not limited thereto. An additional element further added to the copper alloy may be Al, Sn, Pt, Ni, Mn, Ti and like, or a combination thereof, and a content of other added elements including one and two elements apart from copper is preferably limited to within 5 wt %.

The mean particle diameter of copper or copper alloy powder is preferably 5 to 30 μm (micron), more preferably 5 to 20 μm. When the mean particle diameter is less than 5 μm, there are problems in that agglomeration between powder particles occurs and injection of raw materials rapidly becomes difficult, and when the mean particle diameter is greater than 30 μm, the plasma treatment effect is disadvantageously rapidly deteriorated. For this reason, the mean particle diameter is within the range defined above.

According to the present invention, the copper or copper alloy powder is injected at an injection rate of 0.5 to 7 kg/hr, preferably 1 to 5 kg/hr and then passes through a high temperature of thermal plasma torch, reactor and oxygen reaction zone. When the injection rate is less than 0.5 kg/hr, the problem of deteriorated production efficiency occurs, and when the injection rate is higher than 7 kg/hr, nano-particle formation effect is significantly deteriorated. For this reason, the injection rate is preferably maintained within the range defined above. Meanwhile, the injection rate is preferably controlled in proportion to power. For example, an injection rate of 1 kg/hr on average at a power of 60 kW, an injection rate of 3 kg/hr on average at a power of 200 kW and an injection rate of 5 kg/hr on average at a power of 400 kW are preferably maintained.

An operation gas to generate the thermal plasma is, for example, argon, hydrogen or helium. As the amount of added hydrogen increases, nano-particle formation effect is improved. For this reason, hydrogen is preferably added in an amount of 5 to 50% by volume to argon. In particular, when the hydrogen amount is 5% by volume or more, the nano particle formation effect is increased, and when the hydrogen is higher than 50% by volume, the nano-particle formation effect is rapidly deteriorated. For this reason, the hydrogen amount is preferably maintained within the range of 5 to 50% by volume.

According to the present invention, oxygen is continuously injected into the oxygen reaction zone of the back end of the reactor, so that a uniform oxygen passivation layer with a mean thickness of 1 to 30 nm is formed on a surface layer of the copper or copper alloy powder. At this time, when the oxygen reaction zone is disposed in a collector or an oxygen reaction occurs after completely discharge from the nanocopper metal powder manufacturing apparatus of the present invention, it is difficult to form a stable oxide film on the copper or copper alloy powder surface. For this reason, the oxygen reaction zone is disposed at the back end of the reactor to form a uniform oxygen passivation layer on the powder surface immediately after reaction and the location of the oxygen reaction zone may be the front of the cyclone part or the front of the collector. According to the present invention, an operation gas for forming the oxygen passivation layer is oxygen, and the thickness of the passivation layer increases depending on the amount of added oxygen. For this reason, the amount of oxygen added to the oxygen reaction zone is 0.3 to 12 slpm (standard liters per minute), preferably 0.4 to 10 slpm, more preferably 0.5 to 4.5 slpm, with respect to 1 kg of the copper or copper alloy powder injected per hour. When the amount of the added oxygen is less than 0.3 slpm, the passivation layer formation effect is insufficient, and when the amount of added oxygen is higher than 12 slpm, the thickness of the oxygen passivation layer is rapidly increased and production efficiency is rapidly deteriorated due to consumption of excessive energy during light sintering. For this reason, the amount of added oxygen is preferably maintained within the range of 0.3 to 12 slpm. For example, in a case in which the amount of added oxygen is 0.3 to 12 slpm (standard liters per minute), when the copper or copper alloy powder is injected in an amount of 1 kg per hour, oxygen is added in an amount of 0.3 to 12 liter per minute, and when the copper or copper alloy powder is injected in an amount of 3 kg per hour, oxygen is added in an amount of 0.9 to 36 liter per minute, and when the copper or copper alloy powder is injected in an amount of 5 kg per hour, oxygen is added in an amount of 1.5 to 60 liter per minute.

According to the present invention, a nanocopper metal powder for light sintering, suitable for light sintering, that has a mean particle diameter of 50 to 200 nm and a surface oxygen passivation layer with a mean thickness of 1 to 30 nm, can be manufactured through the process described above.

In addition, the present invention provides an apparatus for manufacturing the nanocopper metal powder for light sintering that includes a raw material feeder for feeding a raw material powder, a thermal plasma torch having a thermal plasma high-temperature zone, a reactor for converting the fed raw material powder into nanoparticles through thermal plasma, and an oxygen injector for adding oxygen for passivation reaction.

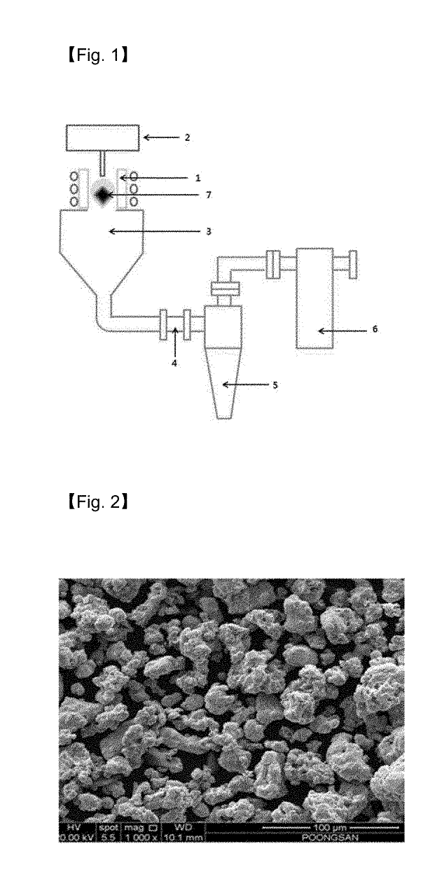

FIG. 1 is a schematic diagram illustrating an example of a thermal plasma apparatus used in the present invention and illustrates a raw material feeder 2 for feeding a raw material powder, a thermal plasma torch 1 having a thermal plasma high-temperature zone 7 provided by application of an electric field to a coil wound outside a water cooling insulation tube in a lower part thereof, a reactor 3 for converting the fed raw material powder into nano-particles through thermal plasma, an oxygen injector 4 for adding oxygen for passivation reaction, a cyclone part 5 for collecting the removed impurities, and a collector 6 for collecting the produced nanocopper metal powder.

The thermal plasma generated by high frequency power is referred to as an “RF thermal plasma (or high frequency plasma)”. The high frequency for generating RF thermal plasma according to the present invention may be within the range of 4 MHz to 13.5 MHz, more preferably, 4 MHz in order to widen the high-temperature zone of RF thermal plasma.

The raw material feeder 2 according to the present invention serves to supply a raw material powder, and is designed to supply the copper or copper alloy powder at an injection rate of 0.5 to 7 kg/hr, as described above.

The oxygen injector 4 according to the present invention serves to inject oxygen into the oxygen reaction zone for passivation reaction, and the present invention can exhibit in-situ process-like effect by incorporating the oxygen injector into the apparatus. In addition, the oxygen reaction zone preferably has a length of 0.05 to 1 m, more preferably, 0.1 to 0.5 m, because a uniform oxygen passivation layer is formed through direct reaction with the surfaces of nano-converted metal particles. Furthermore, the oxygen injector 4 serve to proportionally form an oxide layer on the nanostructured metal particles by constantly supplying oxygen.

In addition, the present invention may further include a cyclone part 5 and a collector 6, and the cyclone part serves to collect impurities removed during the previous processes and the collector serves to collect the produced nanocopper metal powder.

The nanocopper metal powder for light sintering having a uniform oxygen passivation layer according to the present invention may be utilized in a variety of fields, for example, touch screens (transparent electrodes, bezel electrodes), printed FPCBs (in particular, digitizer FPCBs for printing touch sensors), RFID tags, NFCs, solar cells and the like in the printed electronics industry, and in an expanded field including 3D forming FPCBs, stretchable electrodes and the like.

Hereinafter, the present invention will be described in more detail with reference to Example. The following Example is provided only for illustration of the present invention and should not be construed as limiting the scope of the present invention.

### EXAMPLE

The present invention will be described with reference to the following Example.

TABLE 1

| | Mean | | | | | |
|---|---|---|---|---|---|---|
| | particle | | | | | |
| | diameter | Injection | | Mean particle | | |
| | of raw | rate of raw | The amount | diameter of | Thickness of | |
| | material | material | of added | produced | passivation | |
| | powder | powder | oxygen | metal powder | layer | |
| | (μm) | (kg/hr) | (slpm) | (nm) | (nm) | Suitability |
| Example 1 | 12 | 0.5 | 1.0 | 79 | 10 to 15 | Suitable for light |
| (copper) | | | | | | sintering |
| Example 2 | 12 | 0.9 | 1.0 | 98 | 8 to 10 | Suitable for light |
| (copper) | | | | | | sintering |
| Example 3 | 12 | 1.2 | 1.0 | 120 | 5 to 8 | Suitable for light |
| (copper) | | | | | | sintering |
| Example 4 | 12 | 1.5 | 1.0 | 150 | 2 to 5 | Suitable for light |
| (copper) | | | | | | sintering |
| Example 5 | 20 | 0.5 | 1.0 | 115 | 5 to 8 | Suitable for light |
| (copper) | | | | | | sintering |
| Example 6 | 12 | 1.0 | 1.0 | 105 | 3 to 9 | Suitable for light |
| (copper alloy) | | | | | | sintering |
| Example 7 | 20 | 0.5 | 1.0 | 110 | 6 to 11 | Suitable for light |
| (copper alloy) | | | | | | sintering |
| Example 8 | 12 | 0.9 | 3.0 | 98 | 10 to 18 | Suitable for light |
| (copper) | | | | | | sintering |
| Example 9 | 12 | 1.2 | 3.0 | 120 | 6 to 10 | Suitable for light |
| (copper) | | | | | | sintering |
| Example 10 | 12 | 1.5 | 3.0 | 155 | 3 to 6 | Suitable for light |
| (copper) | | | | | | sintering |
| Example 11 | 12 | 0.5 | 10 | 79 | 20 to 30 | Suitable for light |
| (copper) | | | | | | sintering |
| Example 12 | 12 | 0.9 | 10 | 98 | 15 to 20 | Suitable for light |
| (copper) | | | | | | sintering |
| Example 13 | 12 | 1.2 | 10 | 120 | 8 to 15 | Suitable for light |
| (copper) | | | | | | sintering |
| Example 14 | 12 | 1.5 | 10 | 153 | 3 to 8 | Suitable for light |
| (copper) | | | | | | sintering |
| Example 15 | 20 | 0.5 | 10 | 117 | 8 to 15 | Suitable for light |
| (copper) | | | | | | sintering |
| Example 16 | 10 | 3.0 | 0.9 | 85 | 3 to 9 | Suitable for light |
| (copper) | | | | | | sintering |
| Example 17 | 20 | 3.0 | 3.0 | 97 | 8 to 14 | Suitable for light |
| (copper) | | | | | | sintering |
| Example 18 | 25 | 3.0 | 10 | 102 | 10 to 19 | Suitable for light |
| (copper) | | | | | | sintering |
| Example 19 | 10 | 5.0 | 1.5 | 90 | 3 to 8 | Suitable for light |
| (copper) | | | | | | sintering |
| Example 20 | 20 | 5.0 | 3.0 | 98 | 7 to 16 | Suitable for light |
| (copper) | | | | | | sintering |
| Example 21 | 25 | 5.0 | 10 | 110 | 10 to 20 | Suitable for light |
| (copper) | | | | | | sintering |
| Comparative | 1 | 1.0 | 1.0 | 52 | 3 to 12 | Unsuitable due to |
| Example 1 | | | | | | feeding defect |
| (copper) | | | | | | |
| Comparative | 40 | 0.5 | 1.0 | 140 | 3 to 15 | Unsuitable due to |
| Example 2 | | | | | | nano-structure |
| (copper) | | | | | | formation defect |
| Comparative | 12 | 0.2 | 1.0 | 50 | 32 to 53 | Unsuitable due to |
| Example 3 | | | | | | passivation |
| (copper) | | | | | | thickness |
| Comparative | 12 | 10 | 1.0 | 157 | 3 to 20 | Unsuitable due to |
| Example 4 | | | | | | nano-structure |
| (copper) | | | | | | formation defect |
| Comparative | 12 | 1.0 | 0.2 | 120 | 1 to 3 | Unsuitable due to |
| Example 5 | | | | | | burning |
| (copper) | | | | | | |
| Comparative | 12 | 1.0 | 15 | 75 | 33 to 57 | Unsuitable due to |
| Example 6 | | | | | | passivation |
| (copper) | | | | | | thickness |
| Comparative | 12 | 1.0 | X | 99 | X | Unsuitable due to |
| Example 7 | | | | | | passivation |
| (copper) | | | | | | thickness |

### Example 1

A copper powder having a mean particle diameter of 12 μm and a purity of 96% was supplied at an injection rate of 0.5 kg/hr through a raw material feeder into a plasma high-temperature zone. Treatment was conducted with RF thermal plasma having a high-frequency power supply frequency of 4 MHz, as shown in FIG. 1, the raw material powder was melted by thermal plasma, and oxygen passed through the oxygen reaction zone under the condition that the amount of added oxygen was 1 slpm, with respect to 1 kg of the copper or copper alloy powder injected per hour, to form a surface oxygen passivation layer. Then, the oxygen having passed through the reactor to produce a powder and the nanocopper metal powder having been uniformly oxygen-passivated was collected by the collector. As a result, a nanocopper metal powder having a mean particle diameter 79 nm and an oxygen passivation layer thickness of 10 to 15 nm was prepared.

### Example 2

A nanocopper metal powder having a mean particle diameter of 98 nm and an oxygen passivation layer thickness of 8 to 10 nm was prepared in the same manner as in Example 1, except that the injection rate of the copper powder was 0.9 kg/hr.

### Example 3

A nanocopper metal powder having a mean particle diameter of 120 nm and an oxygen passivation layer thickness of 5 to 8 nm was prepared in the same manner as in Example 1, except that the injection rate of the copper powder was 1.2 kg/hr.

### Example 4

A nanocopper metal powder having a mean particle diameter of 150 nm and an oxygen passivation layer thickness of 2 to 5 nm was prepared in the same manner as in Example 1, except that the injection rate of the copper powder was 1.5 kg/hr.

### Example 5

A nanocopper metal powder having a mean particle diameter of 115 nm and an oxygen passivation layer thickness of 5 to 8 nm was prepared in the same manner as in Example 1, except that a copper powder having a mean particle diameter of 20 μm was used.

### Example 6

A nanocopper metal powder having a mean particle diameter of 105 nm and an oxygen passivation layer thickness of 3 to 9 nm was prepared in the same manner as in Example 1, except that a copper alloy powder including Cu and P [copper 95% and phosphorous 5% (wt %)] was used, instead of the copper powder.

### Example 7

A nanocopper metal powder having a mean particle diameter of 110 nm and an oxygen passivation layer thickness of 6 to 11 nm was prepared in the same manner as in Example 1, except that a copper alloy powder including Cu and Ag [copper 95% and silver 5% (wt %)] was used, instead of the copper powder.

### Example 8

A nanocopper metal powder having a mean particle diameter of 98 nm and an oxygen passivation layer thickness of 10 to 18 nm was prepared in the same manner as in Example 1, except that the amount of added oxygen was 3 slpm.

### Example 9

A nanocopper metal powder having a mean particle diameter of 120 nm and an oxygen passivation layer thickness of 6 to 10 nm was prepared in the same manner as in Example 2, except that the amount of added oxygen was 3 slpm.

### Example 10

A nanocopper metal powder having a mean particle diameter of 170 nm and an oxygen passivation layer thickness of 3 to 6 nm was prepared in the same manner as in Example 3, except that the amount of added oxygen was 3 slpm.

### Example 11

A nanocopper metal powder having a mean particle diameter of 79 nm and an oxygen passivation layer thickness of 20 to 30 nm was prepared in the same manner as in Example 1, except that the amount of added oxygen was 10 slpm.

### Example 12

A nanocopper metal powder having a mean particle diameter of 98 nm and an oxygen passivation layer thickness of 15 to 20 nm was prepared in the same manner as in Example 2, except that the amount of added oxygen was 10 slpm.

### Example 13

A nanocopper metal powder having a mean particle diameter of 120 nm and an oxygen passivation layer thickness of 8 to 15 nm was prepared in the same manner as in Example 3, except that the amount of added oxygen was 10 slpm.

### Example 14

A nanocopper metal powder having a mean particle diameter of 170 nm and an oxygen passivation layer thickness of 3 to 8 nm was prepared in the same manner as in Example 4, except that the amount of added oxygen was 10 slpm.

### Example 15

A nanocopper metal powder having a mean particle diameter of 117 nm and an oxygen passivation layer thickness of 8 to 15 nm was prepared in the same manner as in Example 5, except that the amount of added oxygen was 10 slpm.

### Example 16

A nanocopper metal powder having a mean particle diameter of 85 nm and an oxygen passivation layer thickness of 3 to 9 nm was prepared in the same manner as in Example 1, except that a copper powder having a mean particle diameter of 10 μm was used, the injection rate of the copper powder was 3.0 kg/hr, and the amount of added oxygen was 0.9 slpm, with respect to 1 kg of the copper or copper alloy powder injected per hour.

### Example 17

A nanocopper metal powder having a mean particle diameter of 97 nm and an oxygen passivation layer thickness of 8 to 14 nm was prepared in the same manner as in Example 1, except that a copper powder having a mean particle diameter of 20 μm was used, the injection rate of the copper powder was 3.0 kg/hr, and the amount of added oxygen was 3.0 slpm, with respect to 1 kg of the copper or copper alloy powder injected per hour.

### Example 18

A nanocopper metal powder having a mean particle diameter of 102 nm and an oxygen passivation layer thickness of 10 to 19 nm was prepared in the same manner as in Example 1, except that a copper powder having a mean particle diameter of 25 μm was used, the injection rate of the copper powder was 3.0 kg/hr, and the amount of added oxygen was 10 slpm, with respect to 1 kg of the copper or copper alloy powder injected per hour.

### Example 19

A nanocopper metal powder having a mean particle diameter of 90 nm and an oxygen passivation layer thickness of 10 to 19 nm was prepared in the same manner as in Example 1, except that a copper powder having a mean particle diameter of 10 μm was used, the injection rate of the copper powder was 5.0 kg/hr, and the amount of added oxygen was 0.5 slpm, with respect to 1 kg of the copper or copper alloy powder injected per hour.

### Example 20

A nanocopper metal powder having a mean particle diameter of 98 nm and an oxygen passivation layer thickness of 7 to 16 nm was prepared in the same manner as in Example 1, except that a copper powder having a mean particle diameter of 20 μm was used, the injection rate of the copper powder was 5.0 kg/hr, and the amount of added oxygen was 3.0 slpm, with respect to 1 kg of the copper or copper alloy powder injected per hour.

### Example 21

A nanocopper metal powder having a mean particle diameter of 110 nm and an oxygen passivation layer thickness of 10 to 20 nm was prepared in the same manner as in Example 1, except that a copper powder having a mean particle diameter of 25 μm was used, the injection rate of the copper powder was 5.0 kg/hr, and the amount of added oxygen was 10.0 slpm, with respect to 1 kg of the copper or copper alloy powder injected per hour.

### Comparative Example 1

A nanocopper metal powder having a mean particle diameter of 52 nm and an oxygen passivation layer thickness of 3 to 10 nm was prepared in the same manner as in Example 1, except that a copper powder having a mean particle diameter of 1 μm was used. As a result, it could be seen that, when a copper powder smaller than the mean particle diameter of the present invention was used, frequent work defects occurred due to clogging of the feeder.

### Comparative Example 2

A nanocopper metal powder having a mean particle diameter of 140 nm and an oxygen passivation layer thickness of 3 to 15 nm was prepared in the same manner as in Example 1, except that a copper powder having a mean particle diameter of 40 μm was used. As a result, it could be seen that, when a copper powder larger than the mean particle diameter of the present invention was used, incorporation of the raw material powder into cyclone and nanopowder collection rate were disadvantageously extremely low because nanoparticles were not formed well in the reactor.

### Comparative Example 3

A nanocopper metal powder having a mean particle diameter of 50 nm and an oxygen passivation layer thickness of 32 to 53 nm was prepared in the same manner as in Example 1, except that the injection rate of the copper powder was 0.2 kg/hr. As a result, it could be seen that, when an injection rate lower than the injection rate of the present invention was used, the nanocopper metal powder was disadvantageously unsuitable for light sintering due to excessively large thickness of the oxygen passivation layer.

### Comparative Example 4

A nanocopper metal powder having a mean particle diameter of 157 nm and an oxygen passivation layer thickness of 3 to 20 nm was prepared in the same manner as in Example 1, except that the injection rate of the copper powder was 10.0 kg/hr. As a result, it could be seen that, when an injection rate higher than the injection rate of the present invention was used, incorporation of the raw material powder into cyclone and nanopowder collection rate were disadvantageously extremely low because nanoparticles were not formed well in the reactor.

### Comparative Example 5

A nanocopper metal powder having a mean particle diameter of 120 nm and an oxygen passivation layer thickness of 1 to 3 nm was prepared in the same manner as in Example 1, except that the amount of added oxygen was 0.2 slpm. As a result, it could be seen that, when oxygen was added in an amount lower than the amount of added oxygen according to the present invention, handling was unsuitable upon use due to easy burning upon exposure to the air due to formation of excessively thin oxygen passivation layer on the surface.

### Comparative Example 6

A nanocopper metal powder having a mean particle diameter of 75 nm and an oxygen passivation layer thickness of 33 to 57 nm was prepared in the same manner as in Example 1, except that the amount of added oxygen was 15 slpm. As a result, it could be seen that, when oxygen was added in an amount of higher than the amount of added oxygen according to the present invention, the nanocopper metal powder was disadvantageously unsuitable for light sintering due to excessively thick oxygen passivation layer.

### Comparative Example 7

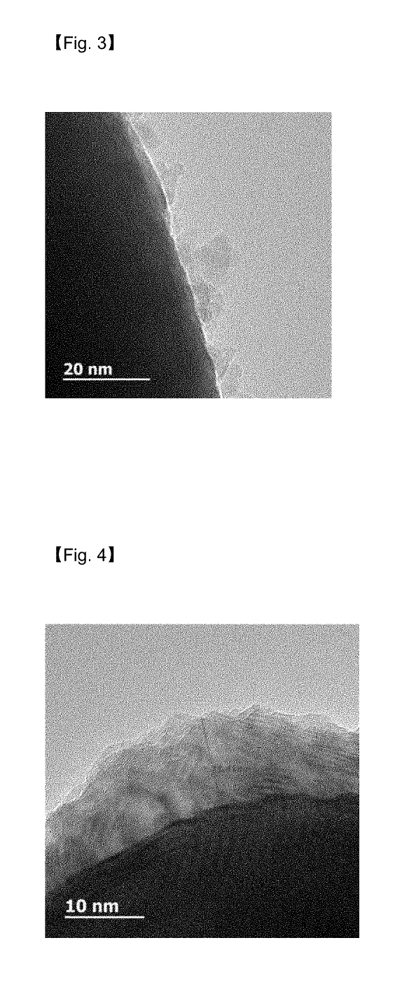

The morphology of oxygen passivation on the surface of copper nano-metal powder when conducting plasma treatment and then natural oxidation for one hour in the same manner as in Example 1, except that the step of adding oxygen was omitted from the process, is shown in FIG. 3. As can be seen from FIG. 3, when the oxygen addition according to the present invention was not conducted, since irregular oxygen passivation thickness was formed on the powder surface layer due to contact with the air, a uniform oxygen passivation layer necessary for stable light sintering could not be formed.

### DESCRIPTION OF REFERENCE NUMBERS

1: RF thermal plasma torch

2: Raw material feeder

3: Reactor

4: Oxygen injector

5: Cyclone part

6: Collector

7: Thermal plasma high-temperature zone

### INDUSTRIAL APPLICABILITY

As described above, the controlled nanocopper metal powder having a uniform oxygen passivation layer suitable for light sintering could be stably secured by using the method according to the present invention.

1. A method for preparing a nanocopper metal powder for light sintering having a mean particle diameter of 50 to 200 nm and a surface oxygen passivation layer with a mean thickness of 1 to 30 nm, the method comprising allowing a copper or copper alloy powder with a mean particle diameter of 5 to 30 μm to pass through a thermal plasma torch, a reactor and an oxygen reaction zone,
wherein the copper or copper alloy powder is injected at an injection rate of 0.5 to 7 kg/hr, and the amount of oxygen added to the oxygen reaction zone with respect to 1 kg of the copper or copper alloy powder injected per hour ranges from 0.3 to 12 slpm (standard liters per minute).

2. The method according to claim 1, wherein a content of copper in the copper alloy powder is 95% by weight or more.

3. The method according to claim 2, wherein the copper alloy comprises one or more selected from the group consisting of Cu—P, Cu—Ag and Cu—Fe,
wherein the copper alloy further comprises one or more elements selected from the group consisting of Al, Sn, Pt, Ni, Mn and Ti,
wherein a total content of one or more elements comprised apart from copper is 5% by weight or less.

4. An apparatus for preparing a nanocopper metal powder for light sintering comprising:
a raw material feeder for feeding a raw material powder;
a thermal plasma torch having a thermal plasma high-temperature zone;
a reactor for converting the fed raw material powder into nanoparticles through thermal plasma; and
an oxygen injector for adding oxygen for passivation reaction.
